(19) United States
(12) Patent Application Publication
(10) Pub. No.: US 2010/0248601 A1
(43) Pub. Date: Sep. 30, 2010

(54) ABRASIVE ARTICLES

(76) Inventor: Derek McGrogan, Lincoln Park, NJ (US)

Correspondence Address: HOFFMANN & BARON, LLP, 6900 JERICHO TURNPIKE, SYOSSET, NY, 11791, US

(21) Appl. No.: 12/376,404

(22) PCT Filed: Aug. 10, 2007
(86) PCT No.: PCT/US07/17829

§ 371 Date: Feb. 4, 2009

Related U.S. Application Data
(60) Provisional application No. 60/837,069, filed on Aug. 10, 2006.

(51) Int. Cl. B24D 11/00; C09K 3/14

(52) U.S. Cl. 451/526; 51/309

(57) ABSTRACT

The subject invention provides abrasive articles for finely polishing surfaces, particularly ceramic containing surfaces. An abrasive article formed in accordance with the subject invention includes a metallic support scaffold having an open, three-dimensional plexus of metallic elements; and, diamond powder interspersed in the plexus. Advantageously, with the subject invention, average surface roughnesses (Ra) of less than about 20 nanometers can be achieved, and more preferably, average surface roughnesses (Ra) of less than about 10 nanometers can be achieved. Also, average surface roughnesses (Ra) of about 7 to 12 nanometers have been repeatedly achieved. Although the subject invention may have applicability in various areas, it is particularly well-suited for use with ceramic containing prosthetic implants, which benefit greatly from very fine surfaces.

### CROSS-REFERENCE TO RELATED APPLICATION

This application claims priority to U.S. Provisional Patent Application No. 60/837,069, filed Aug. 10, 2006, the entire contents of which are hereby incorporated by reference.

### BACKGROUND OF THE INVENTION

This invention relates to abrasive articles for polishing ceramic containing articles and, more particularly, to polishing ceramic containing prosthetic implants.

Prosthetic implants used for hip replacement, knee replacement and so forth are widely used. Concerns exist over debris generated between articulating surfaces of such implants. These concerns are not only based on the longevity of the prosthetic components, but also on the presence of the residue in surrounding body tissue. To minimize wear, various materials and coatings for the articulating surfaces have been developed in the prior art, including ceramic coatings. Finely polished ceramic-coated articulating surfaces reduce wear of the prosthetic components thereby, not only, minimizing generated debris but also extending the useful life of the products. The fineness of the ceramic coated surfaces relates to the surfaces' smoothness and resistance against wear.

### SUMMARY OF THE INVENTION

The subject invention provides abrasive articles for finely polishing surfaces, particularly ceramic containing surfaces. An abrasive article formed in accordance with the subject invention includes a metallic support scaffold having an open, three-dimensional plexus of metallic elements; and, diamond powder interspersed in the plexus. Advantageously, with the subject invention, average surface roughnesses (Ra) of less than about 20 nanometers can be achieved, and more preferably, average surface roughnesses (Ra) of less than about 10 nanometers can be achieved. Also, average surface roughnesses (Ra) of about 7 to 12 nanometers have been repeatedly achieved. Although the subject invention may have applicability in various areas, it is particularly well-suited for use with ceramic containing prosthetic implants, which benefit greatly from very fine surfaces.

These and other features of the invention will be better understood through a study of the following detailed description and accompanying drawings.

### BRIEF DESCRIPTION OF THE DRAWINGS

FIG. 1 is a schematic of a lap cup having an abrasive article formed in accordance with the subject invention mounted thereto.

FIGS. 2 and 3 are schematics showing an alternative mode of mounting an abrasive article formed in accordance with the subjection invention to a lap cup.

FIG. 4 is a schematic of dug-shaped metallic elements useable to form the scaffold.

FIG. 5 shows a schematic of a polishing system formed in accordance with the subject invention.

FIG. 6 shows a side elevational view of an abrasive article formed in accordance with the subject invention.

FIG. 7 is a top plan view of an abrasive article formed in accordance with the subject invention.

FIG. 8 is a variation of FIG. 1 where the lap cup is shown with a concave shape, rather than a convex shape.

### DETAILED DESCRIPTION OF THE INVENTION

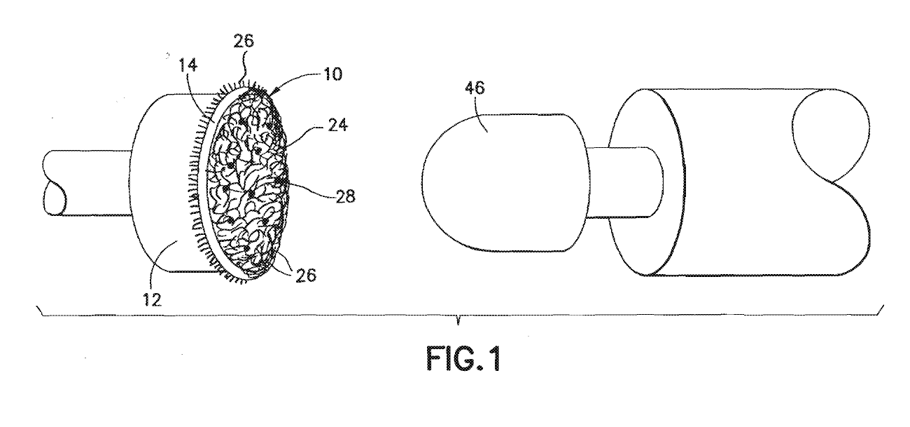

With reference to FIG. 1, an abrasive article 10 is shown mounted to a lap cup 12. The lap cup 12 may be of any design known in the art used in a polishing machine, particularly for polishing spherical or partly spherical shaped objects. By way of non-limiting example, U.S. Pat. No. 3,167,884, which is hereby incorporated by reference, discloses a suitable lap cup and polishing machine. As will be readily recognized by those skilled in the art, various lap cup and polishing machine designs may be utilized with abrasive articles of the subject invention.

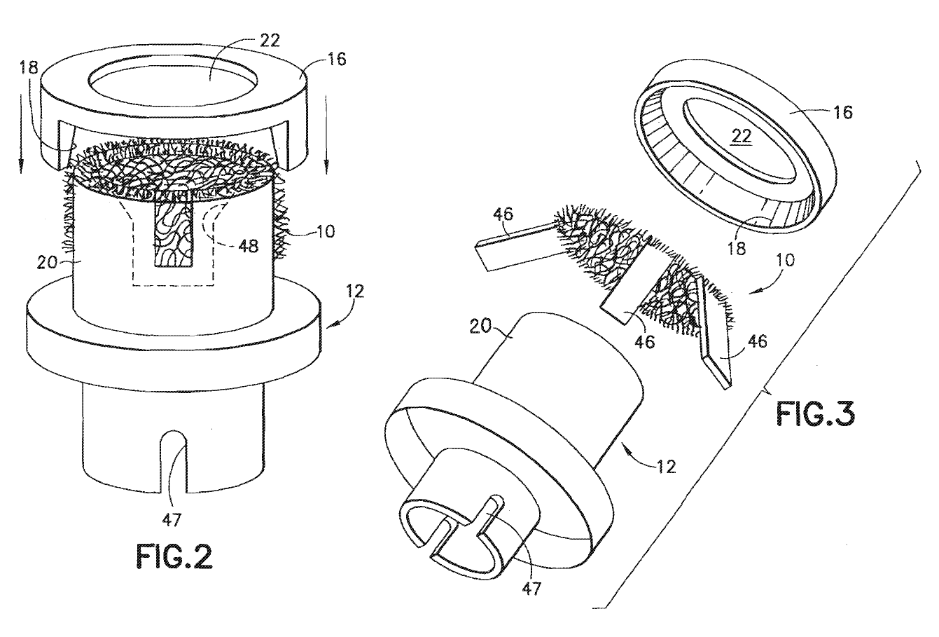

The abrasive article 10 may be used alone or in conjunction with other abrasives or polishing kits. In either regard, the abrasive article 10 is fixed to the lap cup 12 using any known technique, including being fastened using a releasable member, such as an elastomeric member 14, which may be an O-ring or a rubber band. In addition, or alternatively, as shown in FIGS. 2 and 3, the abrasive article 10 may be retained by a rigid locking ring 16 having a tapered wedge-shaped locking element 18, which is preferably annular (FIG. 3) for releasably locking onto a cooperating surface 20 (e.g. friction fit) defined on the lap cup 12. The cooperating surface 20 may be tapered. An opening 22 is formed in the locking ring 16 through which the abrasive article 10 extends during use. It is preferred that the abrasive article 10 be removably fixed to the lap cup 12 to permit replacement upon excessive wear.

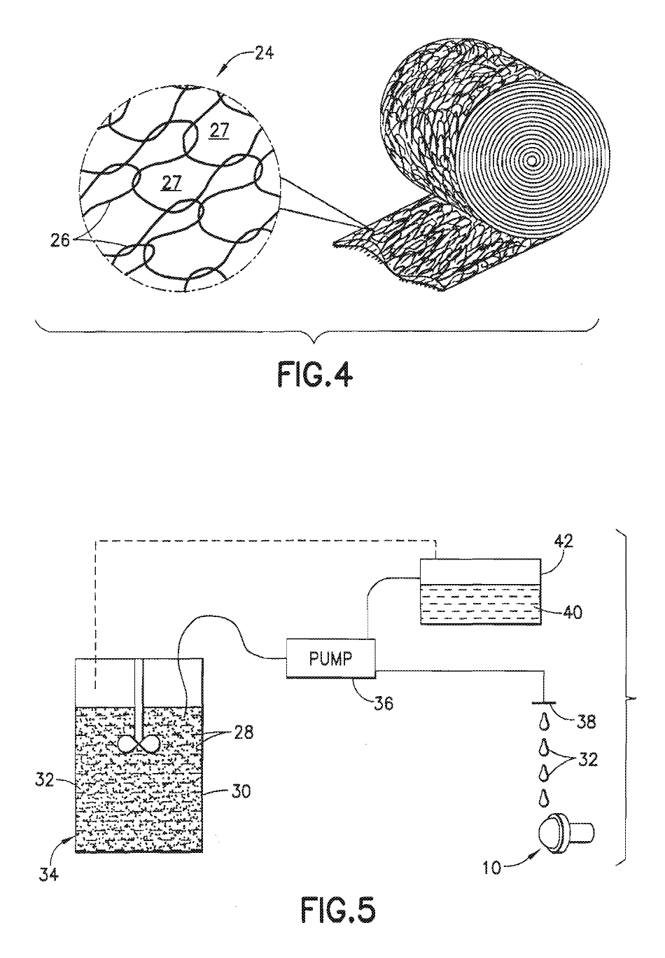

The abrasive article 10 includes a metallic support scaffold 24, which may include iron, such as being formed of steel. It is preferred that the scaffold 24 be of a corrosion-resistant metallic material, such as stainless steel, copper or bronze. In addition, the scaffold 24 is preferably formed as an open, three-dimensional plexus of metallic elements 26. The scaffold 24 may have a gauze-like configuration, such as that defined in metal gauze. More preferably, the scaffold 24 may have a wool-like configuration, such as that defined in steel wool (e.g., grade 0000 through 4). As shown in FIG. 4, with a gauze-like configuration, the metallic elements 26 are interlaced providing the scaffold 24 with a “chain mail” type appearance. The metallic elements 26 may be weaved to define the scaffold 24 with a gauze-like configuration; in addition, or alternatively, the metallic elements 26 may be braided and/or knitted. The metallic elements 26 may be arranged to define various shaped open cells 27 which may be generally polygonal (e.g., rectangular), generally circular, irregular, or combinations thereof. As shown in FIG. 4, the scaffold 24 may be provided in roll form (in a gauze or wool configuration) and out to a desired shape to form the abrasive article 10. It is preferred that the scaffold 24 be stainless steel wool, grade 3, such scaffold being obtainable commercially from McMaster-Carr Supply Company of Elmhurst, Ill.

The abrasive article 10 also includes diamond powder 28, preferably 13,000-200,000 mesh diamond powder, more preferably 100,000 mesh diamond powder, interspersed amongst the elements 26 in the plexus forming the scaffold 24. The diamond powder 28 may be natural, synthetic, or combinations thereof. In addition, the diamond powder 28 may be monocrystal, polycrystal or combinations thereof.

Preferably, the diamond powder 28 is applied to the scaffold 24 during a polishing procedure. As such, it is preferred that the scaffold 24 be first mounted to the lap cup 12 prior to the application of the diamond powder 28. More preferably, and with reference to FIG. 5, the diamond powder 28 is mixed with a liquid carrier 30, preferably de-ionized water, to form a solution 32. The solution 32 is preferably applied to the scaffold 24 during a polishing procedure. It is preferred that the solution 32 be prepared with the diamond powder 28 in the amount of twenty-five (25) carats by weight being mixed with 8-16 fluid ounces (more preferably 8 fluid ounces) of the liquid carrier 30.

By way of non-limiting example, the solution 32 may be prepared by a mixer 34 (e.g., magnetic mixer). The solution 32, once properly mixed, may be drawn from the mixer 34 by a pump 36 (e.g., a peristaltic pump) and delivered to an outlet 38. The outlet 38 is configured to direct the solution 32 onto the abrasive article 10. It is preferred that the outlet 38 administer the solution 32 as drops with the solution 32 being dripped onto the abrasive article 10. The solution 32 may be applied at a rate of about 1 drop per second. The solution 32 may be alternatively sprayed as a mist and/or applied as a liquid stream.

It is preferred that the solution 32 be applied for a portion of the polishing procedure. For example, the solution 32 may be applied from initiation of the polishing procedure and up to approximately 100% of the length of the polishing procedure, preferably for 70% of the entire procedure. The polishing procedure is considered to be the process during which the abrasive article 10 is in actual contact with, and causing abrasion of, an article being polished, as described below.

After the solution 32 has been applied, a rinse liquid 40 may be taken from a source 42 and applied to the abrasive article 10 to wash away residue. The rinse liquid 40 may be applied during and/or after the polishing procedure. Advantageously, the pump 36 may be used to urge the rinse liquid 40 through the outlet 38. It is preferred that the rinse liquid 40 be de-ionized water. It is also preferred that the rinse liquid 40 be applied in drip form, although the rinse liquid 40 may be also applied as a spray mist and/or liquid stream. The rinse liquid 40 may be provided at a rate of about 2 drops per second. The source 42 may be used to also provide the rinse liquid 40 to the mixer 34 as the liquid carrier 30.

Alternatively, the abrasive article 10 may be fully or partially prepared before a polishing procedure and/or before being mounted to the lap cup 12. For example, the scaffold 24 may be sprayed with the solution 32 before a polishing procedure. The diamond powder 28 may be applied using other methods. The techniques discussed above refer to wet application of the diamond powder 28; dry application may be also utilized.

However applied, it is preferred that the diamond powder 28 be non-fixedly disposed on the metallic elements 26. As such, during a polishing procedure, the diamond powder 28 may be transferred to and from an article being polished and the metallic elements 26.

It is preferred that the diamond powder 28 fully cover the scaffold 24 with at least a dusting. It has been found that 5-7 grams of the diamond powder 28, mixed in 8-12 fluid ounces of a liquid carrier (e.g., de-ionized water) is sufficient for a single of the scaffold 24. For a dry application, 0.5 grams of the diamond powder 28 may be utilized for a single of the scaffold 24 in the size of approximately 0.25 inches thick and 3 inches diameter.

The abrasive article 10 may be used to conduct polishing of several different articles. A series of the abrasive articles 10 may be utilized, where the size of the diamond powder 28 is varied amongst the abrasive articles 10 (e.g., going from a more coarse mesh to a finer mesh). It is preferred that the mesh of the diamond powder 28 not be altered for a particular of the abrasive articles 10, once the diamond powder 28 has been applied. Excessive wear of the scaffold 24 will limit the life of the abrasive article 10. The diamond powder 28 is preferably applied for each procedure as described above (e.g., with the solution 32 being dripped onto the abrasive article 10). Where the diamond powder 28 is applied before a polishing procedure, the diamond powder 28 is preferably re-applied prior to initiating a new polishing procedure. Smaller quantities of the diamond powder 28 can be applied for subsequent polishing procedures.

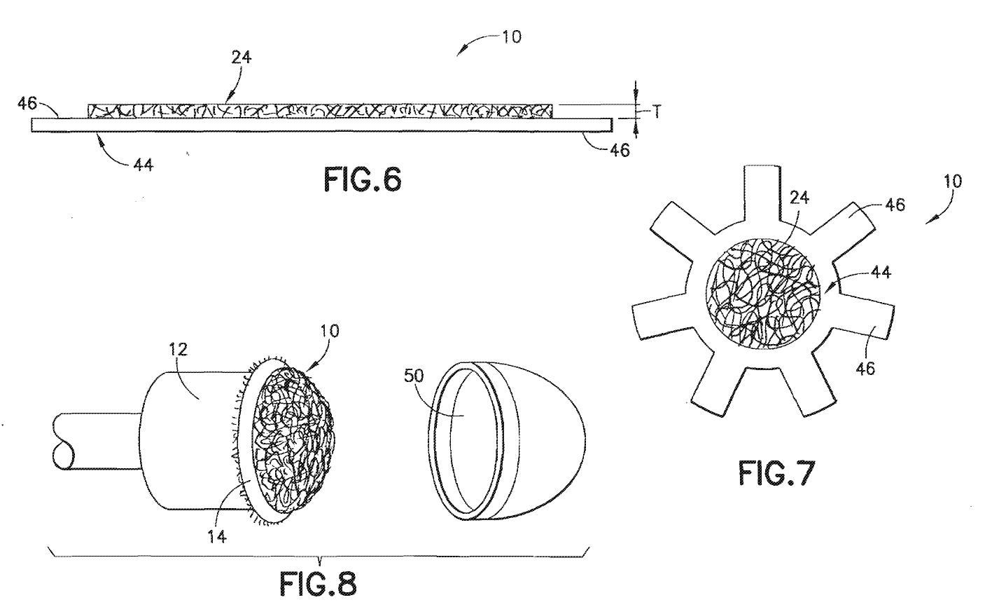

With reference to FIGS. 6 and 7, the abrasive article 10 may be formed with a flexible backing or membrane 44, preferably formed of an elastomeric material, such as perforated rubber (e.g., 1/32 inch thick, durometer of 50 A). The scaffold 24 may be fixed to the flexible backing 30 using any known technique, including, but not limited to, fusing, adhesive bonding, mechanical fixing (e.g., stapling; stitching), and combinations thereof.

It is preferred that the flexible backing 44 extend radially beyond the scaffold 24 to define exposed portions 46. The exposed portions 46 define engagement surfaces for a fixation member (e.g., the elastomeric member 14 or the locking ring 16) to engage against in holding the abrasive article 10 on the lap cup 12. As shown in FIGS. 3 and 7, the exposed portions 46 are preferably discontinuous, such as in the form of radiating strips, to provide flexibility for the flexible backing 44.

Preferably, the scaffold 24, without the flexible backing 44, is formed with a nominal thickness T in the range of about 0.1875-0.25 inches.

The abrasive article 10 may be used to polish ceramic containing materials. The ceramic material may be a coating or may form all or a portion of a solid article. In addition, the ceramic material may be a ceramic, or a ceramic in combination with other materials, such as ceramic/metal alloys (e.g., cermets). With the subject invention, average surface roughnesses (Ra) of less than about 20 nanometers can be achieved, and more preferably, average surface roughnesses (Ra) of less than about 10 nanometers can be achieved. Also, average surface roughnesses (Ra) of about 7 to 12 nanometers have been repeatedly achieved. To repeatedly achieve the aforementioned results, it is preferred that a target surface initially have an average surface roughness (Ra) of 400 nanometers or smoother (i.e., less than 400 nanometers) prior to polishing with the abrasive article 10. As indicated above, the abrasive article 10 can be used independently or in conjunction with each other, or with other abrasive or polishing articles.

Although the abrasive article 10 may have applicability in various areas, it is particularly well-suited for use with ceramic-containing prosthetic implants.

In use, the abrasive article 10 is rotated by the lap cup 12 (e.g., by an arbor) and brought into contact with a surface 46 to be polished, such as a ceramic coated articulating surface of a prosthetic implant. The lap cup 12 may be rotated through engagement with drive slot 47 (FIGS. 2 and 3). The surface 46 is shown in FIG. 1 to be the top end of a femoral implant for hip replacement configured for ball-and-socket engagement with an acetabular implant. The surface 46 may be of any configuration, such as the surface of an acetabular implant as described below. Once contact is achieved between the abrasive article 10 with the surface 46, an abrading action is initiated. To control the polishing action, caused by the abrading, a desired pressure may be applied to the surface 46 along with possible relative oscillation or pivoting between the lap cup 12 and the surface 46. Such oscillation or pivoting permits polishing of a greater portion of the surface 46. In addition, the surface 46 may be rotated. As described above, the diamond powder 28 may be applied to the scaffold 24 during the polishing procedure.

The abrasive article 10 may be used on different configurations of lap cups. For example, with reference to FIGS. 1 and 8, the lap cup 12 has a geometry to permit polishing of a generally spherical, or partially spherical, item, such as the ball-shaped top of a femoral implant for hip replacement. Here, the lap cup 12 generally has a convex shaped support surface 48 underlying the abrasive article 10 (FIG. 2). Alternatively, as shown in FIG. 8, the lap cup 12 may be shaped to polish inside of a spherical or partially spherical surface, such as within articulating surface 50 of an acetabular implant. Here, the lap cup 12 has a generally concave shaped support surface underlying the abrasive article 10. Other geometries are possible.

What is claimed is:

1. An abrasive article comprising:
a metallic support scaffold having an open, three-dimensional plexus of metallic elements; and,
diamond powder interspersed in said plexus.

2. An abrasive article as in claim 1, wherein said diamond powder is 13,000-200,000 mesh diamond powder.

3. An abrasive article as in claim 2, wherein said diamond powder is 100,000 mesh diamond powder.

4. An abrasive article as in claim 2, wherein said diamond powder is 200,000 mesh that diamond powder.

5. An abrasive article as in claim 1, wherein said metallic elements include iron.

6. An abrasive article as in claim 1, wherein said metallic elements are formed from stainless steel.

7. An abrasive article as in claim 1, wherein said metallic elements are formed from bronze.

8. An abrasive article as in claim 1, wherein said diamond powder is non-fixedly disposed on said metallic elements.

9. An abrasive article as in claim 1, wherein said metallic elements are interlaced.

10. An abrasive article as in claim 1, wherein said diamond powder is selected from the group consisting of natural diamond powder, synthetic diamond powder, and combinations thereof.

11. An abrasive article as in claim 1, further comprising a flexible backing, said scaffold being fixed to said flexible backing.

12. An abrasive article as in claim 11, wherein exposed portions of said flexible backing extend radially beyond said scaffold.

13. An abrasive article as in claim 12, wherein said exposed portions are discontinuous.

14. An abrasive article as in claim 1, wherein said scaffold has a nominal thickness in the range of about 0.1875-0.25 inches.

15. An abrasive article as in claim 1, wherein said scaffold has a gauze-like configuration.

16. An abrasive article as in claim 1, wherein said scaffold has a wool-like configuration.

17. An abrasive article as in claim 1, wherein said metallic elements are formed from a corrosion-resistant metal.

18. A process of preparing an abrasive article:
preparing a metallic support scaffold having an open, three-dimensional plexus of metallic elements;
preparing a mixture of a liquid carrier and diamond powder; and
applying said mixture to said plexus.

19. A process as in claim 18, wherein said liquid carrier is de-ionized water.

20. A process as in claim 18, wherein said diamond powder is 100,000-200,000 mesh diamond powder.

21. A process as in claim 18, wherein said step of applying includes dripping said mixture onto said plexus.

22. A process as in claim 18, wherein said step of applying is at least partially conducted while an article is being polished by said metallic support scaffold.

23. A process as in claim 18, wherein said step of preparing a mixture includes mixing 25 carats by weight of said diamond powder with 8-16 fluid ounces of said liquid carrier.
